(19) United States
(12) Patent Application Publication
(10) Pub. No.: US 2015/0214628 A1
(43) Pub. Date: Jul. 30, 2015

(54) CIRCUIT BOARD WITH RADIO COMMUNICATIONS FUNCTION

(71) Applicant: SAMSUNG ELECTRO-MECHANICS CO., LTD., Suwon (KR)

(72) Inventors: Seung Goo JANG, Suwon (KR); Jung Woo KIM, Suwon (KR); Min Hoon KIM, Suwon (KR); You Taek AN, Suwon (KR); Nack Gyun SEONG, Suwon (KR)

(73) Assignee: SAMSUNG ELECTRO-MECHANICS CO., LTD., Suwon (KR)

(21) Appl. No.: 14/307,750

(22) Filed: Jun. 18, 2014

(30) Foreign Application Priority Data
Jan. 27, 2014 (KR) 10-2014-0009556

(51) Int. Cl. H01Q 9/06; H01Q 1/38

(52) U.S. Cl. CPC H01Q 9/06; H01Q 1/38

(57) ABSTRACT

There is provided a circuit board capable of internally transferring a signal through radio communications. The circuit board according to the present disclosure may include: an insulation layer; a first signal transfer circuit formed of a circuit pattern on one surface of the insulation layer; and a second signal transfer circuit formed of a circuit pattern on the other surface of the insulation layer and wirelessly transferring a signal through resonance with the first signal transfer circuit; wherein the first and second signal transfer circuits transfer the signal in a super high frequency (SHF) band or an extremely high frequency (EHF) band.

### CROSS-REFERENCE TO RELATED APPLICATION

This application claims the benefit of Korean Patent Application No. 10-2014-0009556 filed on Jan. 27, 2014, with the Korean Intellectual Property Office, the disclosure of which is incorporated herein by reference.

### BACKGROUND

The present disclosure relates to a circuit board, and more particularly, to a circuit board capable of internally transferring a signal through radio communications.

In a printed circuit board or a multilayer ceramic board formed by stacking a plurality of ceramic sheets according to the related art, a wiring pattern is formed on upper and lower surfaces or in an internal portion of the board. In addition, a conductive via is mainly used in order to electrically connect these wiring patterns to each other.

Such a board according to the related art has mainly been used in a device using a frequency in an ultra-high frequency (UHF) band or a frequency lower than UHF. However, as frequency bands utilized by electronic devices are increased, in the case of using a conductive via to transfer a signal in the board according to the related art, signal loss may increase. Such signal loss may be further intensified in a super high frequency (SHF)/extremely high frequency (EHF) band, commonly seen as a next-generation communications band.

### RELATED ART DOCUMENT

(Patent Document 1) Korean Patent Laid-Open Publication No. 2013-0056570

### SUMMARY

An aspect of the present disclosure may provide a circuit board in which a via according to the related art is omitted and in which a signal may be transferred within the board through radio communications.

According to an aspect of the present disclosure, a circuit board may include: an insulation layer; a first signal transfer circuit formed of a circuit pattern on one surface of the insulation layer; and a second signal transfer circuit formed of a circuit pattern on the other surface of the insulation layer and wirelessly transferring a signal through resonance with the first signal transfer circuit; wherein the first and second signal transfer circuits transfer the signal in a super high frequency (SHF) band or an extremely high frequency (EHF) band.

Each of the first and second signal transfer circuits may include: a wiring pattern; a resonance part connected to one end of the wiring pattern; a ground part disposed so as to be spaced apart from the resonance part; and a connection part electrically connecting the resonance part and the ground part to each other.

The resonance parts of the first and second signal transfer circuits may be disposed in positions corresponding to each other.

The connection parts of the first and second signal transfer circuits may be disposed in positions corresponding to each other.

The resonance parts of the first and second signal transfer circuits may be formed of planar patterns.

The connection parts of the first and second signal transfer circuits may be formed of linear patterns.

Characteristics of the resonance may be determined by inductance L1 of the resonance part of the first signal transfer circuit, inductance L2 of the resonance part of the second signal transfer circuit, and parasitic capacitance C0 generated between the resonance parts of the first and second signal transfer circuits.

A bandwidth and a return loss of the signal may be determined by inductance L3 of the connection part of the first signal transfer circuit, inductance L4 of the connection part of the second signal transfer circuit, capacitance C3 generated between the resonance part and the ground part of the first signal transfer circuit, and capacitance C4 generated between the resonance part and the ground part of the second signal transfer circuit.

L3 and L4 may be formed to be 3 to 5 times L1 or L2 in order to decrease the return loss of the signal.

C3 and C4 may be formed to be 1/30 to 1/10 times C0 in order to decrease the return loss of the signal.

C3 and C4 may be formed to be 1 to 2 times C0 in order to expand a frequency bandwidth of the signal.

The circuit board may further include at least one electronic element connected to the other end of the wiring pattern.

The circuit board may further include: at least one antenna connected to the other end of the wiring pattern of the first signal transfer circuit; and at least one electronic element connected to the other end of the wiring pattern of the second signal transfer circuit.

The first and second signal transfer circuits may be disposed on the insulation layer in plural.

The insulation layer may be a multilayer board in which at least one circuit pattern is formed.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a cross-sectional diagram schematically illustrating a circuit board according to an exemplary embodiment of the present disclosure;

FIG. 2 is an exploded perspective diagram of FIG. 1;

FIG. 3 is a circuit diagram schematically illustrating an equivalent circuit of the circuit board shown in FIG. 2;

FIG. 4 is a graph illustrating a result obtained by measuring a return loss of the circuit board according to an exemplary embodiment of the present disclosure;

FIG. 5 is a graph illustrating a result obtained by measuring a return loss of the circuit board according to another exemplary embodiment of the present disclosure;

FIGS. 6 and 7 are graphs illustrating results obtained by changing a value of C3 and C4 in the circuit board of FIG. 5 and measuring a return loss of the circuit board;

FIGS. 8 and 9 are graphs comparing signal transfer characteristics of the circuit board according to the present exemplary embodiment and a circuit board according to the related art with each other; and

FIG. 10 is a plan diagram schematically illustrating a circuit board according to another exemplary embodiment of the present disclosure.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. In the drawings, the shapes and dimensions of elements may be exaggerated for clarity, and the same reference numerals will be used throughout to designate the same or like elements.

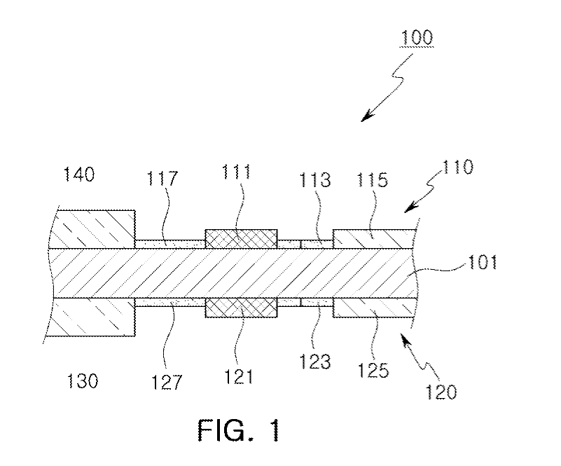

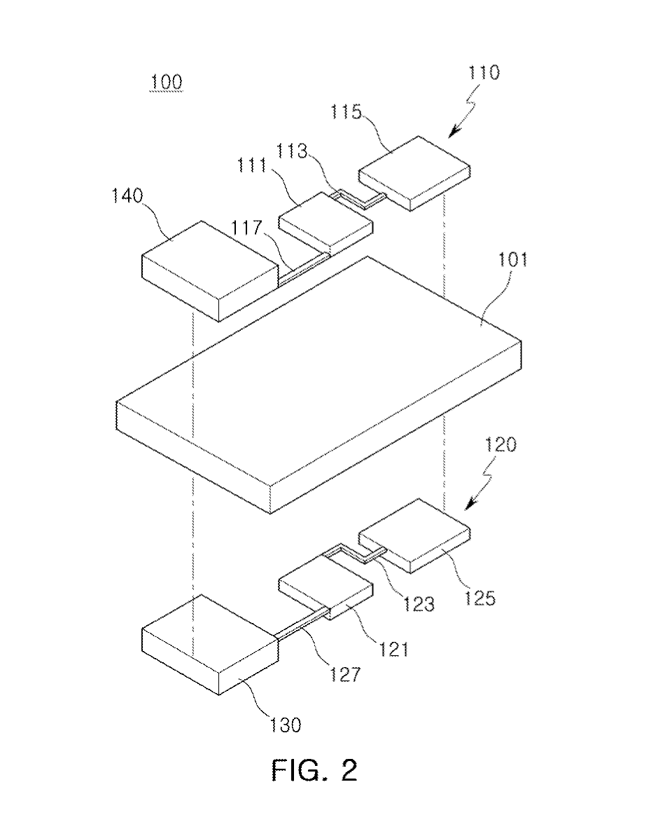

FIG. 1 is a cross-sectional diagram schematically illustrating a circuit board according to an exemplary embodiment of the present disclosure, and FIG. 2 is an exploded perspective diagram of FIG. 1.

Referring to FIGS. 1 and 2, the circuit board 100 according to an exemplary embodiment of the present disclosure may include an insulation layer 101, signal transfer circuits 110 and 120, and a plurality of elements 130 and 140.

The insulation layer 101 may be a board on which an electronic element such as an active element or a passive element is mounted on at least one surface thereof. However, the insulation layer is not limited thereto, but may be a single insulating material layer or a plurality of insulating material layers stacked in the board.

In the case in which the insulation layer 101 is formed of a board, various kinds of boards (for example, a ceramic board, a printed circuit board, a flexible board, or the like) well known in the art may be used as the board. In addition, both surfaces of the board may be provided with mounting electrodes for mounting electronic components thereon or circuit patterns electrically interconnecting the mounting electrodes.

The board may be a multilayer board formed of a plurality of layers. In this case, a circuit pattern may be formed between each of the layers of the board.

Further, a cavity (not shown) in which electronic elements may be embedded may be formed in the board according to the present exemplary embodiment.

The signal transfer circuits 110 and 120 may be formed on both surfaces of the insulation layer 101. The signal transfer circuits 110 and 120 may be provided in a form of a circuit pattern and formed of a metal having excellent conductivity such as Cu, Ni, Al, Ag, Au, and the like.

The signal transfer circuits 110 and 120 may include a first signal transfer circuit 110 formed on one surface of the insulation layer 101 and a second signal transfer circuit 120 formed on the other surface thereof, and the first and second signal transfer circuits 110 and 120 may include wiring pattern parts 117 and 127, resonance parts 111 and 121, connection parts 113 and 123, and ground parts 115 and 125, respectively.

The wiring pattern parts 117 and 127 may be formed as portions of the circuit pattern formed on the insulation layer 101 and include a first wiring pattern 117 formed on one surface of the insulation layer 101 and a second wiring pattern 127 formed on the other surface thereof.

The first and second wiring patterns 117 and 127 may be formed in a manner in which they face each other based on the insulation layer 101, but are not limited thereto.

Resonance parts 111 and 121 to be described below may be connected to one ends of the wring pattern parts 117 and 127, and at least one electronic element 130 and 140 may be connected to the other ends thereof. Here, the electronic element may include an element 130 transferring a signal and an antenna 140 receiving the signal transferred from the element 130 to radiate the transferred signal to the outside. Here, the element 130 may be a radio frequency integrated circuit (RFIC), but is not limited thereto.

In addition, the case in which the antenna 140 is connected to the first wiring pattern 117 and the element 130 is connected to the second wiring pattern 127 is described by way of example in the present exemplary embodiment. However, the configuration of the present disclosure is not limited thereto, but may be variously modified when needed. For example, the element rather than the antenna may be connected to the first wiring pattern 117.

The resonance parts 111 and 121 may include a first resonance part 111 formed on one surface of the insulation layer 101 and a second resonance part 121 formed on the other surface thereof.

The first and second resonance parts 111 and 121 may be disposed on both surfaces of the insulation layer 101, respectively, and formed in a shape in which the first and second resonance parts 111 and 121 face each other, based on the insulation layer 101, similarly to the first and second wiring patterns 117 and 127.

The first and second resonance parts 111 and 121 may be formed of a flat planar circuit patterns having a predetermined area and electrically connected to the first and second wiring patterns 117 and 127, respectively.

That is, the first resonance part 111 may be disposed at a distal end of the first wiring pattern 117 to thereby be electrically connected to the first wiring pattern 117, and the second resonance part 121 may be disposed at a distal end of the second wiring pattern 127 to thereby be electrically connected to the second wiring pattern 127.

Further, in the circuit board 100 according to the present exemplary embodiment, a signal is transferred through resonance of the first and second resonance parts 111 and 121. Therefore, the first and second resonance parts 111 and 121 may be formed to have the same shape as each other and be disposed in the manner in which they face each other based on the insulation layer 101. However, the first and second resonance parts 111 and 121 are not limited thereto, but may be formed in a different shape when needed.

Meanwhile, although the case in which the first and second resonance parts 111 and 121 are formed of a tetragonal circuit pattern is described by way of example in the present exemplary embodiment, the present disclosure is not limited thereto. That is, the first and second resonance parts 111 and 121 may have various shapes such as a polygonal shape, a circular shape, or the like, when needed.

The connection parts 113 and 123 may electrically connect the resonance parts 111 and 121 and ground parts 115 and 125 to be described below to each other. To this end, the connection parts 113 and 123 may include a first connection part 113 connecting the first resonance part 111 and a first ground part 115 to each other and a second connection part 123 connecting the second resonance part 121 and a second ground part 125.

The connection parts 113 and 123 may be provided in a form of a circuit pattern formed on the insulation layer 101, similarly to the wiring pattern parts 117 and 127, and be formed of a linear pattern having a width narrower than that of the resonance parts 111 and 121.

The ground parts 115 and 125 may be provided in a form of a circuit pattern and formed in a linear shape similarly to the wiring pattern parts 117 and 127 or a plane shape similarly to the resonance parts 111 and 121.

The ground parts 115 and 125 may be electrically connected to the resonance parts 111 and 121 via the connection parts 113 and 123. Therefore, the ground parts 115 and 125 may include the first ground part 115 electrically connected to the first resonance part 111 and the second ground part 125 electrically connected to the second resonance part 121. In addition, the first and second ground parts 115 and 125 may be electrically connected to each other when needed.

The circuit board 100 according to the present exemplary embodiment configured as described above may include the first and second resonance parts 111 and 121 disposed in two circuit pattern layers spaced apart from each other by the insulation layer 101 so as to face each other. In addition, the circuit board 100 may include the connection parts 113 and 123 connecting the resonance parts 111 and 121 and the ground parts 115 and 125, respectively.

Here, the signal in the circuit board 100 may be transferred through resonance of the first and second resonance parts 111 and 121. Therefore, the first and second resonance parts 111 and 121 may be disposed so as to be spaced apart from each other by a distance at which resonance may occur in a SHF/EHF band.

That is, the insulation layer 101 according to the present exemplary embodiment may have a thickness and be formed of a material such that resonance may occur between the first and second resonance parts 111 and 121 in the SHF/EHF band.

The circuit board 100 according to the present exemplary embodiment configured as described above may have high signal transfer efficiency in the SHF/EHF band as compared to a circuit board using a via according to the related art.

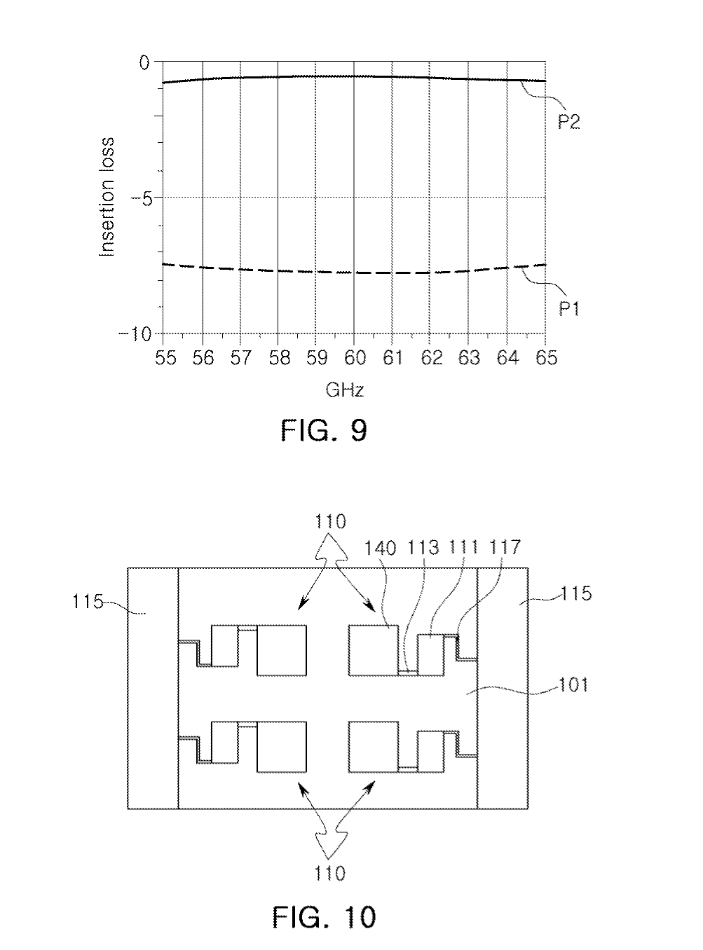

FIGS. 8 and 9 are graphs comparing signal transfer characteristics of the circuit board according to the present exemplary embodiment and a circuit board according to the related art with each other. Here, FIG. 8 is a graph comparing return loss, and FIG. 9 is a graph illustrating comparing insertion loss. Further, in the case in which a signal was transferred in a 60 GHz band, the measurement was preformed, and the results were shown.

Referring to FIG. 8, it was measured that in a circuit board P2 according to the present exemplary embodiment of the present disclosure, the return loss was significantly low as compared to a circuit board P1 using a via according to the related art, and particularly, the return loss was −20 dB or less in the vicinity of 60 GHz.

On the contrary, in the circuit board P1 according to the related art, the measured return loss was entirely about −1 dB, such that it may be appreciated that the return loss was significantly high, and it was not easy to substantially transfer a signal in the SHF/EHF band.

In addition, referring to FIG. 9, the circuit board P2 according to the present exemplary embodiment, it was measured that the insertion loss was higher than about −1 dB. Further, it was measured that in the circuit board P1 using a via according to the related art, the insertion loss was lower than about −7 dB. Therefore, it may be appreciated that in the circuit board P2 according to the present exemplary embodiment, attenuation of a transfer signal was low in the SHF/EHF band as compared to the circuit board P1 according to the related art.

As described above, it may be appreciated that in the circuit board according to the present exemplary embodiment, the signal transfer characteristics in the SHF/EHF band were significantly improved as compared to the circuit board using a via according to the related art.

Meanwhile, the connection parts 113 and 123 of the circuit board according to the present exemplary embodiment may be used to determine a signal transfer frequency and improve reflection characteristics in addition to a function of electrically connecting the resonance parts 111 and 121 and the ground parts 115 and 125 to each other.

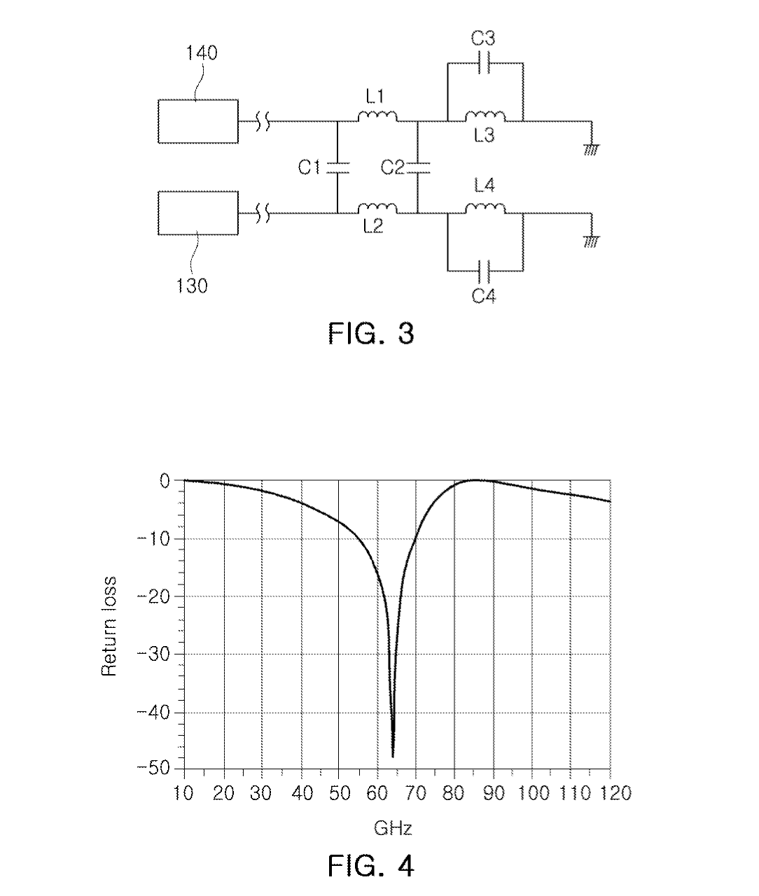

FIG. 3 is a circuit diagram schematically illustrating an equivalent circuit of the circuit board shown in FIG. 2.

Here, L1 and L2 shown in FIG. 3 are structural inductances of the first and second resonance parts 111 and 121, respectively, and C1 and C2 are parasitic capacitances (hereinafter, collectively referred to as C0) that do not structurally exist but are generated by electrical coupling between two surfaces since the first and second resonance parts 111 and 121 are disposed so as to face each other.

The circuit configured to include L1, L2, C1, and C2 may have a basic structure capable of transferring a signal using resonance characteristics.

In addition, L3 and L4 are inductances of the first and second connection parts 113 and 123, respectively. Further, C3 is parasitic capacitance generated between the first resonance part 111 and the first ground part 115, and C4 is parasitic capacitance generated between the second resonance part 121 and the second ground part 125. Here, C3 and C4 may be formed by side surfaces of the resonance part 111 and 121 and the ground parts 115 and 125 facing each other.

The circuit configured to include L3, L4, C3, and L4 may be used to determine a bandwidth of the transfer signal and reflection characteristics and adjust the transfer frequency.

The connection parts 113 and 123 according to the present exemplary embodiment may be applied to decrease reflectivity of a signal transferred to the elements 130 and 140 to increase signal transfer efficiency in the vicinity of a resonance frequency band in addition to the function of electrically connecting the resonance parts 111 and 121 and the ground parts 115 and 125 to each other as described above.

To this end, inductances L3 and L4 of the connection parts 113 and 123 may be formed to be three to five times L1 or L2, equal to inductance of the resonance part 111 or 121. Here, a specific value (or inductance) of L3 and L4 may be determined depending on a bandwidth of a communications system transferring signals.

In the case in which L3 and L4 are formed to be less than three times L1 or L2, impedance by the L3 and L4 may be decreased, such that leakage of the signal to the ground parts 115 and 125 may be increased. Therefore, the signal transfer efficiency may be rather decreased.

Further, in the case in which L3 and L4 are formed to be more than 5 times L1 or L2, impedance by the L3 and L4 may be increased, an effect of improving the signal transfer efficiency may be insignificant.

Therefore, in the connection parts 113 and 123 according to the present exemplary embodiment, in the case in which L3 and L4 are formed to be three to five times L1 or L2, equal to inductance of the resonance part 111 or 121, the signal transfer efficiency may be increased.

Further, in the circuit board 100 according to the present exemplary embodiment, the signal transfer efficiency may be increased through a value (or capacity) of C3 and C4, and additionally, a frequency bandwidth may be expanded.

In detail, during a manufacturing process of the circuit board 100, the value of C3 and C4 is formed to be in a range of 1/30 to 1/10 times C0 (C1 or C2), such that the signal transfer efficiency may be increased.

Here, in the case in which the value of C3 and C4 is formed to be more than 1/10 times C0, since impedance may be decreased, the signal may be leaked to the ground part 115 through C3 and C4, such that signal transfer efficiency may be decreased.

Further, in the case in which the value of C3 and C4 is formed to be less than 1/30 times C0, since impedance may be increased, the effect of improving the signal transfer efficiency may be insignificant.

Therefore, in the circuit board 100 according to the present exemplary embodiment, in the case in which the value of C3 and C4 is formed to be in the range of 1/30 to 1/10 times C0, the signal transfer efficiency may be increased.

More specifically, in the circuit board 100 according to the present exemplary embodiment, a value of L3 and L4 is formed to be three to five times L1 or L2, or the value of C3 and C4 is formed to be in the range of 1/30 to 1/10 times C0, such that the signal transfer efficiency may be increased.

FIG. 4 is a graph illustrating a result obtained by measuring a return loss of the circuit board according to an exemplary embodiment of the present disclosure.

The graph of FIG. 4 shows a return loss measured in a circuit board 100 in which C1 and C2 and L1 and L2 were set to 0.02 pF and 0.175 nH, respectively, in order to transfer a signal in a 60 GHz band, and L3 and L4 and C3 and C4 were set to 0.7 nH and 0.001 pF, respectively, in a communications system having a bandwidth less than 10 GHz.

In this case, it may be appreciated that the return loss was further decreased in the resonance frequency band when being compared with the graph of FIG. 8. Therefore, it may be appreciated that the signal transfer efficiency was increased.

Meanwhile, in the present exemplary embodiment, C1 and C2 and L1 and L2 are not limited to the above-mentioned values, but may be set to various values in order to determine a basic resonance frequency. Further, in the case in which L3, L4, C3, and C4 may also be set to various values as long as the values are in the above-mentioned range.

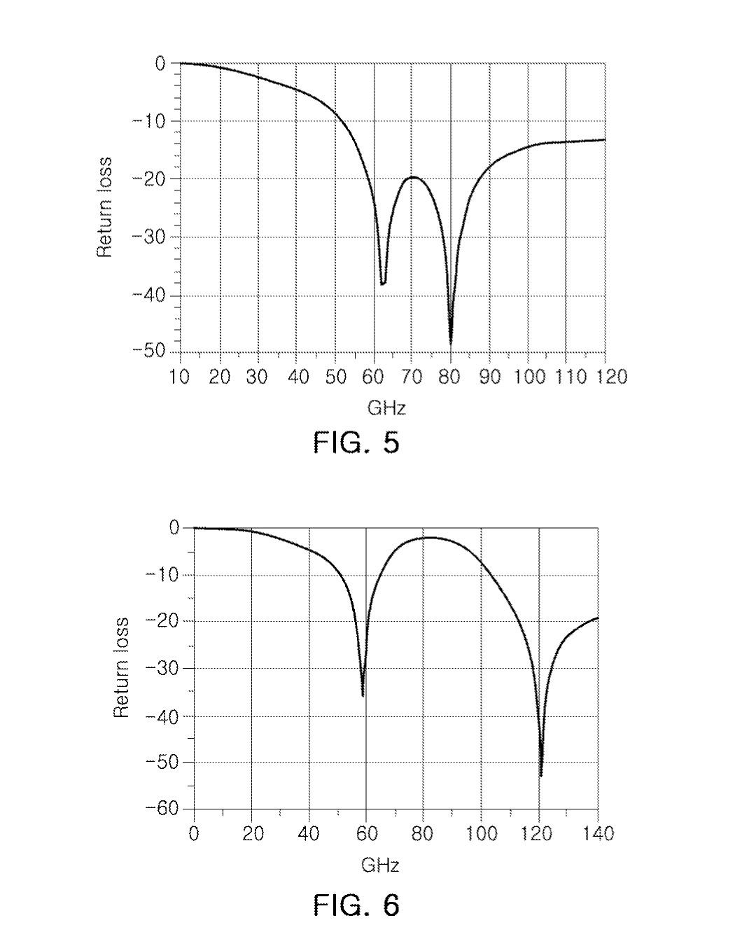

Further, in the circuit board 100 according to the present exemplary embodiment, in the case in which the value of C3 and C4 is in a range of 1 to 2 times C0, a resonance frequency of the transferred signal may be added as shown in FIG. 5. Therefore, in this case, a frequency bandwidth of the entire transfer signal may be expanded.

FIG. 5 is a graph illustrating a result obtained by measuring a return loss of the circuit board according to another exemplary embodiment of the present disclosure. The graph of FIG. 5 shows a return loss measured in a circuit board 100 in which C1 and C2 and L1 and L2 were set to 0.02 pF and 0.175 nH, respectively, in order to transfer a signal in a 60 GHz band, and L3 and L4 and C3 and C4 were set to 0.7 nH and 0.03 pF, respectively, in order to expand a bandwidth to 10 GHz or more.

In this case, when being compared with the graph shown in FIG. 4, it may be confirmed that the resonance frequency was additionally formed at a 80 GHz band, such that the frequency bandwidth was expanded.

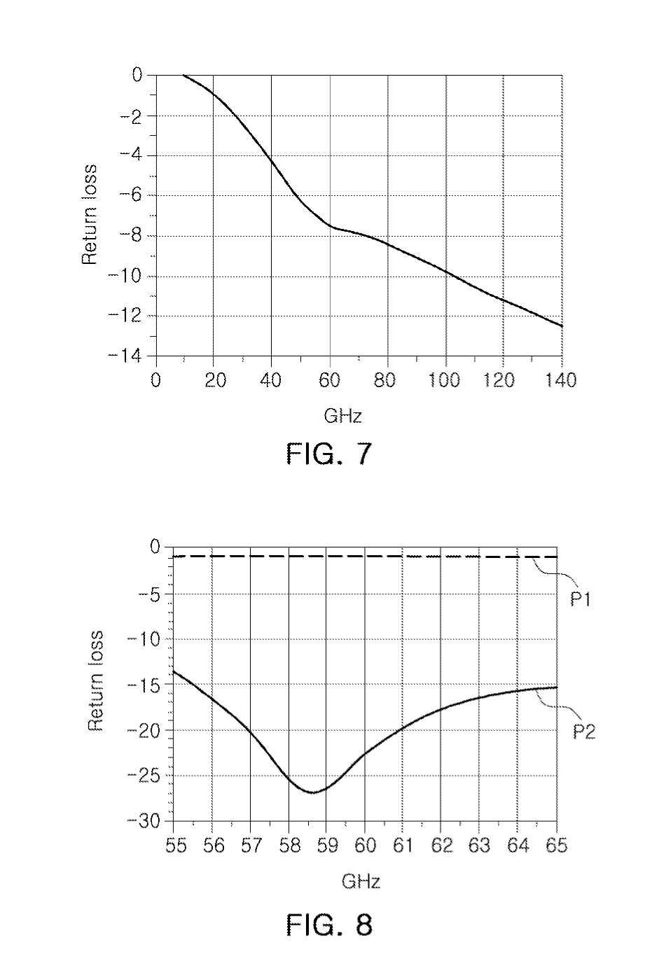

FIGS. 6 and 7 are graphs illustrating results obtained by changing the value of C3 and C4 in the circuit board of FIG. 5 and measuring a return loss of the circuit board. Here, FIG. 6 is a graph illustrating a result obtained by setting C3 and C4 to 0.019 pF, which is less than one time of C0 (0.02 pF), and measuring the return loss, and FIG. 7 is a graph illustrating a result obtained by setting C3 and C4 to 0.042 pF, which is more than two times C0 (0.02 pF), and measuring the return loss.

In the case in which the value of C3 and C4 is less than C0, since the added resonance frequency may be significantly spaced apart from the basic resonance frequency formed by L1, L2, C1, and C2 as shown in FIG. 6, it may be difficult to use the added resonance frequency, such that it may be substantially difficult to expand the frequency bandwidth.

Further, in the case in which the value of C3 and C4 is formed to be more than 2 times C0, the added resonance frequency hinders resonance of the basic resonance frequency as shown in FIG. 7, such that the reflection characteristics may be rather deteriorated.

Therefore, it may be appreciated that in the circuit board 100 according to the present exemplary embodiment, in the case in which the value of C3 and C4 is 1 to 2 times C0, the frequency bandwidth may be more effectively expanded.

Meanwhile, in the case in which the value of C3 and C4 is formed to be 1 to 2 times C0 in order to expand the frequency bandwidth, since the value of C3 and C4 is not in the range of 1/30 to 1/10 times C0, the signal transfer efficiency may not be increased.

Therefore, in this case, the value of L3 and L4 is formed to be 3 to 5 times L1 or L2, and the value of C3 and C4 is formed to be 1 to 2 times C0, such that the signal transfer efficiency may be increased, and the frequency bandwidth may be expanded.

The circuit board according to the present disclosure configured as described above is not limited to the above-mentioned embodiments but may be variously modified.

FIG. 10 is a plan diagram schematically illustrating a circuit board according to another exemplary embodiment of the present disclosure.

Referring to FIG. 10, the circuit board 100 according to the present exemplary embodiment may include a plurality of first signal transfer circuits 110 configured to include a first wiring pattern 117, a first resonance part 111, a first connection part 113, and a first ground part 115 on one surface of an insulation layer 101. In addition, the first wiring patterns 117 may be connected to antennas 140, respectively.

Here, the first signal transfer circuits 110 may be electrically connected to each other so as to share a single or plurality of first ground parts 115.

Further, a plurality of second signal transfer circuits including a second wiring pattern, a second resonance part, a second connection part, and a second ground part that are not shown may be disposed on the other surface of the insulation layer 101 at positions corresponding to the first signal transfer circuit 110, respectively.

In this case, each of the signal transfer circuits may be independently operated. That is, in the circuit board 100 according to the present exemplary embodiment, various signals may be transferred independently from each other through each of the signal transfer circuits.

In addition, the case in which the signal transfer circuits are disposed on both surfaces of the insulation layer, respectively, is described in the above-mentioned exemplary embodiment. However, the present disclosure is not limited thereto.

For example, an insulation protective layer may be formed on the signal transfer circuit, or another insulation layer may be stacked on the signal transfer circuit. Further, the present disclosure may be variously modified. For example, if necessary, the circuit board may be configured so that a plurality of signal transfer circuits are disposed between a plurality of insulation layers forming a multilayer board to thereby transfer a signal to each other.

As set forth above, in the circuit board according to exemplary embodiments of the present disclosure, the signal transfer characteristics in the SHF/EHF band may be significantly improved as compared to the circuit board using the via according to the related art.

While exemplary embodiments have been shown and described above, it will be apparent to those skilled in the art that modifications and variations could be made without departing from the spirit and scope of the present disclosure as defined by the appended claims.

What is claimed is:

1. A circuit board comprising:
an insulation layer;
a first signal transfer circuit formed of a circuit pattern on one surface of the insulation layer; and
a second signal transfer circuit formed of a circuit pattern on the other surface of the insulation layer and wirelessly transferring a signal through resonance with the first signal transfer circuit;
wherein the first and second signal transfer circuits transfer the signal in a super high frequency (SHF) band or an extremely high frequency (EHF) band.

2. The circuit board of claim 1, wherein each of the first and second signal transfer circuits includes:
a wiring pattern;
a resonance part connected to one end of the wiring pattern;
a ground part disposed so as to be spaced apart from the resonance part; and
a connection part electrically connecting the resonance part and the ground part to each other.

3. The circuit board of claim 2, wherein the resonance parts of the first and second signal transfer circuits are disposed in positions corresponding to each other.

4. The circuit board of claim 2, wherein the connection parts of the first and second signal transfer circuits are disposed in positions corresponding to each other.

5. The circuit board of claim 2, wherein the resonance parts of the first and second signal transfer circuits are formed of planar patterns.

6. The circuit board of claim 2, wherein the connection parts of the first and second signal transfer circuits are formed of linear patterns.

7. The circuit board of claim 3, wherein characteristics of the resonance are determined by inductance L1 of the resonance part of the first signal transfer circuit, inductance L2 of the resonance part of the second signal transfer circuit, and parasitic capacitance C0 generated between the resonance parts of the first and second signal transfer circuits.

8. The circuit board of claim 7, wherein a bandwidth and a return loss of the signal are determined by inductance L3 of the connection part of the first signal transfer circuit, inductance L4 of the connection part of the second signal transfer circuit, capacitance C3 generated between the resonance part and the ground part of the first signal transfer circuit, and capacitance C4 generated between the resonance part and the ground part of the second signal transfer circuit.

9. The circuit board of claim 8, wherein L3 and L4 are formed to be 3 to 5 times L1 or L2 in order to decrease the return loss of the signal.

10. The circuit board of claim 9, wherein C3 and C4 are formed to be 1/30 to 1/10 times C0 in order to decrease the return loss of the signal.

11. The circuit board of claim 9, wherein C3 and C4 are formed to be 1 to 2 times C0 in order to expand a frequency bandwidth of the signal.

12. The circuit board of claim 2, further comprising at least one electronic element connected to the other end of the wiring pattern.

13. The circuit board of claim 2, further comprising:
at least one antenna connected to the other end of the wiring pattern of the first signal transfer circuit; and
at least one electronic element connected to the other end of the wiring pattern of the second signal transfer circuit.

14. The circuit board of claim 1, wherein the first and second signal transfer circuits are disposed on the insulation layer in plural.

15. The circuit board of claim 1, wherein the insulation layer is formed of a multilayer board in which at least one circuit pattern is formed.
